(19) United States
(12) Patent Application Publication
(10) Pub. No.: US 2006/0166021 A1
(43) Pub. Date: Jul. 27, 2006

(54) Process for applying a layer of branched polyamide to a substrate

(75) Inventors: Jan De Kroon, Heythuysen (NL); Ted Brink, Maastricht (NL)

Correspondence Address: MAYER, BROWN, ROWE & MAW LLP, 1909 K STREET, N.W., WASHINGTON, DC, 20006, US

(73) Assignee: DSM IP Assets B.V., TE Heerlen (NL)

(21) Appl. No.: 10/520,704

(22) PCT Filed: Jul. 4, 2003
(86) PCT No.: PCT/NL03/00495

§ 371 Date: Jul. 29, 2005

(30) Foreign Application Priority Data
Jul. 9, 2002 (NL) 1021031

(51) Int. Cl. B32B 27/34

(52) U.S. Cl. 428/474.4

(57) ABSTRACT

Process for manufacturing a laminate includes the application of a layer of polyamide to a substrate. The polyamide used is mainly branched polyamide that is at least composed of units derived from AB monomers that a) have both a carboxylic acid group and an amine group; b) at least one compound I, being a carboxylic acid (Aᵥ) with functionality v≧2 or an amine (B_{w}) with functionality w≧2; c) at least one compound II, being a carboxylic acid (Aᵥ) with functionality v≧3 or an amine (B_{w}) with functionality w≧3, with compound II being a carboxylic acid if compound I is an amine, or with compound II being an amine if compound I is a carboxylic acid. The substrate may be (metallized) paper or paperboard so that a laminate is formed which is very suitable for manufacturing packaging for foodstuffs.

The invention relates to a process for manufacturing a laminate, which at least comprises applying a layer of polyamide to a substrate.

Such a method is known, for example, from WO 01/40055. In this document a paperboard substrate is coated by means of extrusion coating with, seen from the paperboard to the outside, a nylon layer, a tie layer and a polyethylene layer.

A disadvantage of the known method resides in the fact that at high production speeds the film-shaped extrudate tends to become unstable so that the substrate is unevenly coated in terms of thickness. This instability is expressed in the fact that the still molten extrudate does not remain flat but starts to exhibit irregular wave patterns so that local differences in thickness are formed. As a rule the amplitude of the waves is greatest at the edges of the substrate, a certain width of which must therefore usually be cut off after the coating as being unusable. If several layers are extruded at the same time, this effect occurs to an even greater extent.

The aim of the invention is to provide a process with which substrates can at a high speed be coated with at least a layer of polyamide.

This aim is achieved according to the invention in that as polyamide mainly branched polyamide is used that is at least composed of units derived from:
a. AB monomers, which are understood to mean a monomer that has both a carboxylic acid group (A) and an amine group (B),
b. at least one compound I, being a carboxylic acid (Aᵥ) with functionality v≧2 or an amine (B_{w}) with functionality w≧2,
c. at least one compound II, being a carboxylic acid (Aᵥ) with functionality v≧3 or an amine (B_{w}) with functionality w≧3, with compound II being a carboxylic acid if compound I is an amine or with compound II being an amine if compound I is a carboxylic acid, wherein the quantities of units, derived from all the carboxylic acids and amines in the polyamide, satisfy formula 1
   P<1/[(F_{A}−1).(F_{B}−1)] (1)
   in which:
   P=[Σ(nᵢ.fᵢ)]_{X}/[Σ(nᵢ.fᵢ)]_{Y} (2)
   in which P≦1 and either X=A and Y=B, or X=B and Y=A and
   F=Σ(nᵢ.fᵢ²)/Σ(nᵢ.fᵢ) (3)
   for respectively all carboxylic acids (F_{A}) and amines (F_{B}),), wherein fᵢ is the functionality of a carboxylic acid (vᵢ) or amine (wᵢ), nᵢ is the number of moles of a carboxylic acid or amine and the summation is carried out over all units derived from carboxylic acids and amines in the polyamide.

The specified branched polyamdies are known from WO-00/35992 and the definitions given there for the various components in the above formula apply here also. In particular compound I and compound II are also understood to be mixtures of several carboxylic acids having the same functionality or mixtures of several amines having the same functionality.

This choice of material appears to result in a significantly more stable extrudate, which means that it remains practically flat, even at high production speeds and even when several layers are applied to the substrate simultaneously. As a result, production speeds that are up to 50% higher can be achieved.

This choice further gives polyamide layers with a highly uniform external appearance without the irregularities caused by gels. Very suitable for application in the process according to the invention is branched polyamide in which caprolactam is the most frequently occurring monomeric unit.

A further advantage of the process according to the invention is the reduction that can be achieved in the edge waste in the form of cut-off parts of the polyamide layer or in the form of substrate coated with a polyamide layer of varying thickness. As a result, less starting material is necessary to manufacture the same surface area of laminated substrate and less material needs to be recycled or destroyed.

Laminates as meant here consist of a generally flat, solid substrate, for example of paper, paperboard, metal foil or sheet or plastic film. The layer of polyamide is applied to the substrate as a functional layer that gives the laminate the properties of the polyamide. In the case of paper or paperboard this is in particular the provision of a barrier to air, oxygen and aromatic substances. To reduce the permeability to moisture as well, at least a layer of high-density or low-density polyethylene is as a rule applied over the polyamide layer and optionally also other functional layers. It is also possible to apply functional layers to the side of the substrate that faces away from the polyamide layer. Suitable combinations of layers of different materials are known per se for the various intended applications of the obtained laminate. Such substrates that are coated with several layers are widely applied in packagings for foodstuffs, for example in the form of cartons or metal cans for milk or fruit juices. In these, the polyamide layer preferably borders directly on the substrate, which if desired can be provided with a layer of metal foil. Between the successive functional layers that give certain properties to the laminate, tie layers can be applied. If a polyethylene layer is applied over the branched polyamide layer, suitable materials for a tie layer are for example modified polyolefins such as LDPE, LLDPE, metallocene PE, polyethylene vinyl alcohol, polyethylene acrylic acid, polyethylene methacrylic acid and polypropylene, which are grafted with at least a compound chosen from the group consisting of α,β-unsaturated dicarboxylic acids, for example maleic acid, fumaric acid and itaconic acid and anhydrides, acid esters, imides and imines thereof. It is also possible to use copolymers of ethylene and the said dicarboxylic acids, modified in the indicated manner, as a tie layer.

If the layers are immediately bordering on each other, that is without a separate tie layer, the layer of the polymer bordering on the polyamide layer preferably consists of a mixture of said polymer and a material described in the above as suitable for use as a be layer, in the case of polyethylene the above-mentioned modified polyolefins, to promote the adhesion between the successive layers. It is also possible for both or one of the successive layers to be modified so as to improve the mutual adhesion.

The layer or layers are applied to the substrate by means of techniques that are known and suitable for this, in particular by extrusion coating. Extrusion coating is a technique known per se for applying film-shaped layers of molten plastic, for example polyamide, polyethylene, polypropylene, ethylene vinyl alcohol and thermoplastics, to solid substrates such as paper, paperboard, metal foil and plastic film. The substrate may in itself also consist of several layers, which have for example been applied to each other in one or more previous process steps. It is also possible to apply several layers, for example the polyamide layer and a tie layer for a next layer to be applied later, simultaneously to the substrate by coextrusion of these layers.

The thickness of the layers can be chosen in accordance with the desired effect. Polyamide layers with increasing thickness, for example, form a better barrier to oxygen and aromatic substances. In practice, the thickness can be between 1 and 100 grams per square metre. Very suitable is a thickness between 5 and 50 grams per square metre. The preceding also applies to any other functional layers, it being noted that a tie layer can generally be thinner than the layers which are tied to each other by the tie layer. In packaging applications the said polyethylene layer is often used to seal the packaging by means of heat sealing and the layer thickness required for this is a more determining factor than the requirement set by the moisture barrier properties.

The polyamide applied consists mainly of branched polyamide, which is understood to mean that in addition to the branched polyamide a quantity of non-branched polyamide may also be present. This quantity should be limited in such a way that the beneficial effects of the application of the branched polyamide are not lost to an unacceptable degree. Preferably at least 50% of the polyamide in the polyamide layer is branched polyamide, and more preferably at least 75% and even at least 90%. The beneficial effect of the presence of the branched polyamide is most manifest when all the polyamide in the layer is branched polyamide. Mixtures of different branched polyamides can also be applied as branched polyamide.

The polyamide may further contain the usual additives, for example nucleating agents, lubricants, antistatics, anti-blocking agents, colourants and stabilizers. This holds equally for the other layers optionally applied.

The invention further relates to a laminate comprising a substrate and a layer consisting mainly of a branched polyamide as defined hereinbefore, the use of this laminate for manufacturing food stuff packages and food stuff packages, comprising this laminate.

1. Process for manufacturing a laminate, which at least comprises the application of a layer of polyamide to a substrate, which as polyamide mainly branched polyamide is used that is at least composed of units derived from:
a. AB monomers, which are understood to mean a monomer that has both a carboxylic acid group (A) and an amine group (B),
b. at least one compound I, being a carboxylic acid (Aᵥ) with functionality v≧2 or an amine (B_{w}) with functionality w≧2,
c. at least one compound II, being a carboxylic acid (Aᵥ) with functionality v≧3 or an amine (B_{w}) with functionality w≧3, with compound II being a carboxylic acid if compound I is an amine or with compound II being an amine if compound I is a carboxylic acid, wherein the quantities of units, derived from all the carboxylic acids and amines in the polyamide, satisfy formula 1
P<1/[(F_{A}−1).(F_{B}−1)] (1)
in which:
P=[Σ(ηᵢ.fᵢ)]_{X}/[Σ(ηᵢ.fᵢ)]_{Y} (2)
in which P≦1 and either X=A and Y=B, or X=B and Y=A and
F=Σ(ηᵢ.fᵢ²)/Σηᵢ.fᵢ) (3)
for respectively all carboxylic acids (F_{A}) and amines (F_{B}), wherein fᵢ is the functionality of a carboxylic acid (vᵢ) or amine (wᵢ), ηᵢ is the number of moles of a carboxylic acid or amine and the summation is carried out over all units derived from carboxylic acids and amines in the polyamide.

2. Process according to claim 1, in which the layer of polyamide is applied by extrusion coating.

3. Process according to claim 1, in which the substrate is a metal or is paper or paperboard, optionally coated with a layer of a metal foil.

4. Laminate comprising a substrate and a layer consisting mainly of a branched polyamide that is at least composed of units derived from:
a. AB monomers, which are understood to mean a monomer that has both a carboxylic acid group (A) and an amine group (B),
b. at least one compound I, being a carboxylic acid (Aᵥ) with functionality v≧2 or an amine (B_{w}) with functionality w≧2,
c. at least one compound II, being a carboxylic acid (Aᵥ) with functionality v≧3 or an amine (B_{w}) with functionality w≧3, with compound II being a carboxylic acid if compound I is an amine or with compound II being an amine if compound I is a carboxylic acid, wherein the quantities of units, derived from all the carboxylic acids and amines in the polyamide, satisfy formula 1
P<1/[(F_{A}−1).(F_{B}−1)] (1)
in which:
P=[Σ(ηᵢ.fᵢ)]_{X}/[Σ(ηᵢ.fᵢ)]_{Y} (2)
in which P≦1 and either X=A and Y=B, or X=B and Y=A and
F=Σ(ηᵢ.fᵢ²)/Σ(ηᵢ.fᵢ) (3)
for respectively all carboxylic acids (F_{A}) and amines (F_{B}), wherein fᵢ is the functionality of a carboxylic acid (vᵢ) or amine (wᵢ), ηᵢ is the number of moles of a carboxylic acid or amine and the summation is carried out over all units derived from carboxylic acids and amines in the polyamide.

5. Use of the laminate according to claim 4 for manufacturing a packaging for foodstuffs.

6. Packaging for foodstuffs, comprising the laminate according to claim 4.

7. Process according to claim 2, in which the substrate, is a metal or is paper or paperboard, optionally coated with a layer of a metal foil.

8. Process for packaging foodstuffs which comprises providing a laminate according to claim 4, and packaging said foodstuffs therein.

9. A packaged foodstuff comprising a wrapper comprising the laminate according to claim 4, and a foodstuff packaged within said wrapper.
